(19) United States
(12) Patent Application Publication
(10) Pub. No.: US 2023/0366363 A1
(43) Pub. Date: Nov. 16, 2023

(54) CYLINDER BLOCK

(71) Applicant: TOYOTA JIDOSHA KABUSHIKI KAISHA, Toyota-shi (JP)

(72) Inventors: Satoshi KAWAI, Chiryu-shi (JP); Tomoaki SUZUKI, Nagoya-shi (JP)

(73) Assignee: TOYOTA JIDOSHA KABUSHIKI KAISHA, Toyota-shi (JP)

(21) Appl. No.: 18/313,499

(22) Filed: May 8, 2023

(30) Foreign Application Priority Data
May 11, 2022 (JP) 2022-078376

(51) Int. Cl. F02F 1/16

(52) U.S. Cl. CPC F02F 1/16

(57) ABSTRACT

A cylinder block is provided. A water jacket spacer is disposed inside a water jacket of the cylinder block. The water jacket includes a first passage connecting an inlet to a discharge section, and a second passage connecting the inlet to the discharging portion. The first passage is shorter than the second passage. A spacer plate of the water jacket spacer is provided with a restricting portion. The restricting portion is located in the first passage. A width dimension of the restricting portion is larger than a width dimension in a cylinder-radial direction of the spacer plate, the cylinder-radial direction being a radial direction of the cylinder. A width dimension of the restricting portion is smaller than a width dimension in the cylinder-radial direction of the water jacket.

### BACKGROUND

### 1. Field

The present disclosure relates to a cylinder block.

### 2. Description of Related Art

Japanese Laid-Open Patent Publication No. 2021-195934 discloses a cylinder block for an internal combustion engine. The cylinder block includes cylinder bores, a coolant passage, a coolant inlet, and a coolant outlet. The cylinder bores are linearly arranged. The coolant passage surrounds the cylinder bore.

The coolant inlet and the coolant outlet communicate with the coolant passage, and are located at an outer peripheral portion of the cylinder bore provided at one end in the arrangement direction of the cylinder bores. The coolant inlet and the coolant outlet face each other in a direction orthogonal to the arrangement direction.

The coolant that has entered the coolant passage from the coolant inlet branches into two directions in the coolant passage and flows to the coolant outlet.

### SUMMARY

In one general aspect, a cylinder block includes a water jacket surrounding a cylinder of an internal combustion engine, a water jacket spacer disposed inside the water jacket, an inlet that conduct coolant into the water jacket, and a discharge section that discharges the coolant from the water jacket. The water jacket includes a first passage connecting the inlet to the discharge section, and a second passage connecting the inlet to the discharge section. The first passage is shorter than the second passage. The water jacket spacer includes a spacer plate and a restricting portion provided on the spacer plate. The restricting portion is located in the first passage. A width dimension of the restricting portion is larger than a width dimension in a cylinder-radial direction of the spacer plate. The cylinder-radial direction is a radial direction of the cylinder. The width dimension of the restricting portion is smaller than a width dimension in the cylinder-radial direction of the water jacket.

In the above configuration, the restricting portion has a width dimension larger than the width dimension of the spacer plate. Thus, the passage cross-sectional flow area of the portion of the first passage in which the restricting portion is provided is smaller than the cross-sectional flow area of the second passage. Therefore, the coolant is less likely to flow to the first passage. As a result, the amount of the coolant flowing to the first passage becomes smaller than the amount of the coolant flowing to the second passage. Therefore, the decrease in the cooling efficiency of the internal combustion engine is reduced.

The restricting portion has a width dimension smaller than the width dimension of the water jacket. Thus, when the water jacket spacer is inserted into and disposed in the water jacket, a gap is provided between the restricting portion and each of a radially outer partition wall and a radially inner partition wall of the water jacket. Therefore, it is possible to prevent wear of the restricting portion and the water jacket due to friction between the restricting portion and the water jacket.

In the structure described in the above document, the coolant inlet and the coolant outlet are located in the outer peripheral portion of the cylinder bore located at one end in the arrangement direction of the cylinder bores. Thus, the lengths of the two passages of the coolant, which are branched in the two directions, are different from each other. Hereinafter, the shorter passage is referred to as a first passage and the longer passage is referred to as a second passage.

Since the length of that part of the second passage that is adjacent to the cylinder bores is longer than that of the first passage, the coolant flowing through the second passage absorbs a larger amount of heat from the cylinder bores than the coolant flowing through the first passage. Further, since the pressure loss of the coolant flowing through the second passage is larger than the pressure loss of the coolant flowing through the first passage, the amount of the coolant flowing through the second passage can be smaller than the amount of the coolant flowing through the first passage in the structure of the above document. This reduces the cooling efficiency of the internal combustion engine. The configuration described above suppresses such a decrease.

In the above-described cylinder block, the restricting portion includes a thick portion formed integrally with the spacer plate. A width dimension in the cylinder-radial direction of the thick portion is partially increased in the spacer plate.

With the above-described configuration, the restricting portion is easily implemented.

In the above-described cylinder block, in the first passage, a direction toward the inlet is an upstream direction, and a direction toward the discharge section is a downstream direction. The width dimension in the cylinder-radial direction of the thick portion decreases toward a downstream side.

With the above-described configuration, by increasing the width dimension of the upstream section of the thick portion, it is possible to reduce the cross-sectional flow area of the section of the first passage, in which the restriction portion is provided. Further, by narrowing the width dimension of the downstream section of the thick portion, the downstream portion of the thick portion is further less likely to come into contact with the partition wall of the water jacket when the water jacket spacer is disposed by being inserted into the water jacket.

In the above-described cylinder block, an interior of the thick portion is hollow.

With the above configuration, when the water jacket spacer is disposed by being inserted into the water jacket, the load acting on the thick portion is dispersed even if the thick portion comes into contact with the partition wall of the water jacket. Therefore, wear of the thick portion and the water jacket is further suppressed.

In the above-described the cylinder block, a direction toward a center of the cylinder in the cylinder-radial direction is an inward direction, and a direction away from the center in the cylinder-radial direction is an outward direction. In each of the first passage and the second passage, a direction toward the inlet is an upstream direction, and a direction toward the discharge section is a downstream direction. The restricting portion is an elastic member separate from the spacer plate. The elastic member includes an attachment portion attached to the spacer plate, and a movable piece. The movable piece includes a connection portion connected to an inner side or an outer side of the attachment portion. The movable piece extends upstream from the connection portion so that the movable piece is wider in the cylinder-radial direction than the width dimension in the cylinder-radial direction of the spacer plate with reference to the connection portion.

With the above configuration, the coolant flowing from the upstream side to the downstream side may enter between the movable piece and the attachment portion. Therefore, the movable piece spreads away from the attachment portion in the cylinder-radial direction with respect to the connection portion. As a result, the width dimension in the cylinder-radial direction of the restricting portion becomes larger than the width dimension in the cylinder-radial direction of the spacer plate. Therefore, the amount of the coolant flowing through the first passage can be made smaller than the amount of the coolant flowing through the second passage.

Further, the movable piece is an elastic member. Thus, when the water jacket spacer is disposed by being inserted into the water jacket, a load is less likely to act on the water jacket even if the movable piece comes into contact with the radially outer partition wall and the radially inner partition wall of the water jacket. Therefore, it is possible to suppress wear of the water jacket.

Other features and aspects will be apparent from the following detailed description, the drawings, and the claims.

### BRIEF DESCRIPTION OF THE DRAWINGS

FIG. 1 is a plan view of a cylinder block according to a first embodiment.

FIG. 2 is a perspective view of a water jacket spacer according to the first embodiment shown in FIG. 1.

FIG. 3 is an enlarged plan view of the cylinder block according to the first embodiment shown in FIG. 1.

FIG. 4 is a cross-sectional view taken along line 4-4 of FIG. 3.

FIG. 5 is a cross-sectional view taken along line 5-5 of FIG. 4.

FIG. 6 is a cross-sectional plan view corresponding to FIG. 3, illustrating of a cylinder block according to a second embodiment when coolant is not flowing through it.

FIG. 7 is a cross-sectional plan view of the cylinder block according to the second preferred embodiment shown in FIG. 6 when the coolant is flowing through it.

FIG. 8 is an enlarged plan view corresponding to FIG. 3, illustrating a cylinder block according to a modification of the first embodiment instead.

FIG. 9 is an enlarged plan view corresponding to FIG. 3, illustrating a cylinder block according to another modification of the first embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

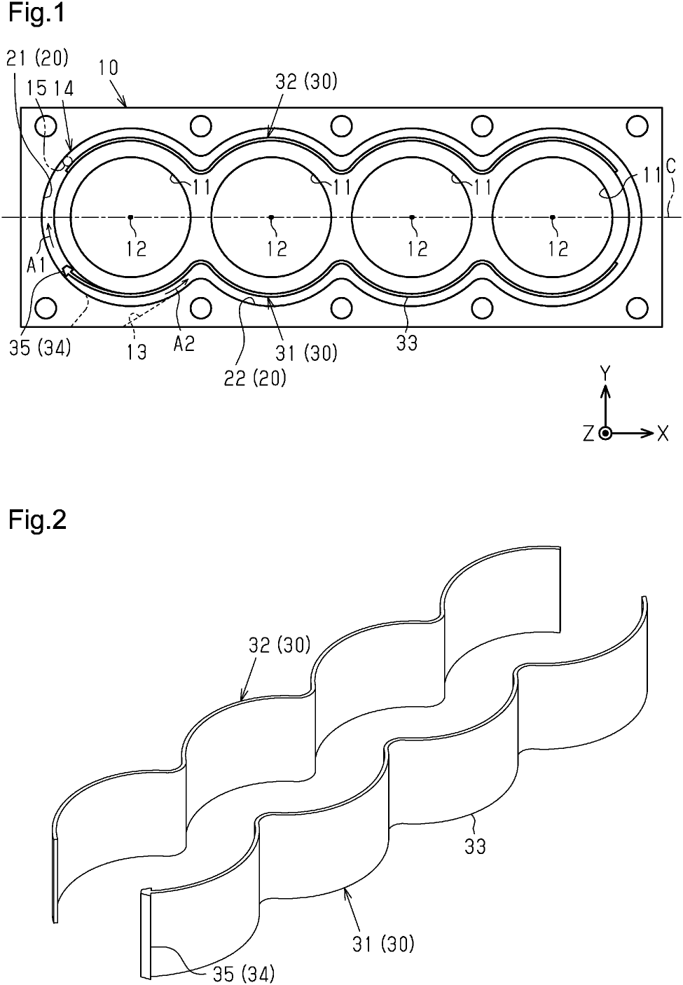

Hereinafter, a cylinder block 10 according to a first embodiment will be described with reference to FIGS. 1 to 5.

As shown in FIG. 1, the cylinder block 10 of an internal combustion engine includes cylinders 11, a water jacket 20, and water jacket spacers 30. The cylinder block 10 is made of metal. The cylinder block 10 has a rectangular shape in plan view, and has a pair of long sides and a pair of short sides.

Hereinafter, the long-side direction of the cylinder block 10 is referred to as a length direction X, and the short-side direction of the cylinder block 10 is referred to as a width direction Y. A direction orthogonal to the length direction X and the width direction Y is referred to as a height direction Z.

### Cylinders 11

As shown in FIG. 1, the four cylinders 11 are linearly arranged in the length direction X (left-right direction in FIG. 1) of the cylinder block 10. Each cylinder 11 has a cylinder bore as a hole extending in the height direction Z (a direction perpendicular to the sheet of FIG. 1) and has a circular shape having a center 12 in plan view.

Hereinafter, in a radial direction of each cylinder 11, a direction toward the center 12 of the cylinder 11 is referred to as an inward direction, and a direction away from the center 12 in the radial direction of the cylinder 11 is referred to as an outward direction. The radial direction of the cylinder 11 may be referred to as a cylinder-radial direction. In particular, the radial direction of the cylinder 11 at the left end in FIG. 1 may represent the cylinder-radial direction.

### Water Jacket 20

As shown in FIG. 1, the water jacket 20 is provided to surround the four cylinders 11. The water jacket 20 has a wavy shape curved in accordance with the shape of the outer periphery of the cylinders 11.

As shown in FIG. 4, the water jacket 20 defines a groove extending in the height direction Z. The groove serves as a passage through which coolant flows. The water jacket 20 includes a radially outer partition wall 23, a radially inner partition wall 24, and a bottom wall 25 to define the groove. The radially outer partition wall 23 and the radially inner partition wall 24 extend in the height direction Z. The radially outer partition wall 23 and the radially inner partition wall 24 are inner walls that face each other in the cylinder-radial direction. The lowest point of the radially outer partition wall 23 and the lowest point of the radially inner partition wall 24 in the height direction Z are connected to each other by the bottom wall 25.

As shown in FIG. 1, the water jacket 20 is connected to an inlet 13 through which coolant is conducted into the water jacket 20. The inlet 13 is formed in a wall portion of the cylinder block 10, and in the present embodiment, the inlet 13 is located at a lower left section of the cylinder block 10 in FIG. 1. For example, the inlet 13 is positioned so as to correspond to the cylinder 11 at the left end as viewed in FIG. 1 among the four cylinders 11 arranged in a line. The water jacket 20 also includes a discharge section 14. In the present embodiment, the discharge section 14 and an inflow port 15 are located at an upper left section of the cylinder block 10 as viewed in FIG. 1. The cylinder head (not shown) is provided with a water jacket (not shown). The cylinder head has the inflow port 15 communicating with the water jacket of the cylinder head and the water jacket 20 of the cylinder block 10. Coolant flows into the water jacket of the cylinder head from the discharge section 14 through the inflow port 15. The discharge section 14 overlaps with the inflow port 15 in plan view. For example, the inlet 13 and the discharge section 14 are positioned so as to sandwich the cylinder 11 at the left end in FIG. 1 among the four cylinders 11, which are arranged in a line.

The water jacket 20 includes a first passage 21 connecting the inlet 13 and the discharge section 14 to each other, and a second passage 22 connecting the inlet 13 and the discharge section 14 to each other. The first passage 21 and the second passage 22 are defined by the radially outer partition wall 23, the radially inner partition wall 24, and the bottom wall 25. The first passage 21 is shorter than the second passage 22. The lengths of the first passage 21 and the second passage 22 are lengths in a direction along the side surface of the cylinder 11 when the cylinder block 10 is viewed from the height direction Z as shown in FIG. 1. For example, the length of the first passage 21 corresponds to a half circumference of the cylinder 11 at the end among the four cylinders 11, which are arranged in a row. For example, the length of the second passage 22 corresponds to the remaining three cylinders 11 among the four cylinders 11, which are arranged in a row.

Hereinafter, the direction toward the inlet 13 in the first passage 21 is referred to as an upstream direction, and the direction toward the discharge section 14 is referred to as a downstream direction.

### Water Jacket Spacers 30

As shown in FIG. 1, the water jacket spacers 30 include a first water jacket spacer 31 and a second water jacket spacer 32. The first water jacket spacer 31 and the second water jacket spacer 32 are made of plastic.

As shown in FIG. 1, a straight line passing through all the centers 12 of the four cylinders 11 is defined as an imaginary straight line C. The first water jacket spacer 31 and the second water jacket spacer 32 are disposed on opposite sides the imaginary straight line C inside the water jacket 20. Each of the first water jacket spacer 31 and the second water jacket spacer 32 has a shape in which four arches are connected. The first water jacket spacer 31 is adjacent to the inlet 13, and the second water jacket spacer 32 is adjacent to the discharge section 14.

As shown in FIGS. 1 to 3, the first water jacket spacer 31 includes a spacer plate 33 and a restricting portion 34 provided in the spacer plate 33. The spacer plate 33 extends from the first passage 21 to the second passage 22. The restricting portion 34 is located in the first passage 21.

As shown in FIGS. 1 and 2, the spacer plate 33 has a wavy shape curved in accordance with the shape of the water jacket 20. That is, the spacer plate 33 has a shape in which four arches are connected.

As shown in FIG. 4, the dimensions of the spacer plate 33 and the restricting portion 34 in the height direction Z are shorter than the dimension of the water jacket 20. That is, the height dimension of the spacer plate 33 and the restricting portion 34 is shorter than the height dimension of each of the radially outer partition wall 23 and the radially inner partition wall 24. The spacer plate 33 and the restricting portion 34 are in contact with the bottom wall 25 of the water jacket 20.

As shown in FIGS. 1 to 3, in the first embodiment, the restricting portion 34 is a thick portion 35 formed integrally with the spacer plate 33. In the thick portion 35 in plan view, a width dimension in the cylinder-radial direction is partially increased in the spacer plate 33. The thick portion 35 is provided at a downstream end of the spacer plate 33 in the first passage 21.

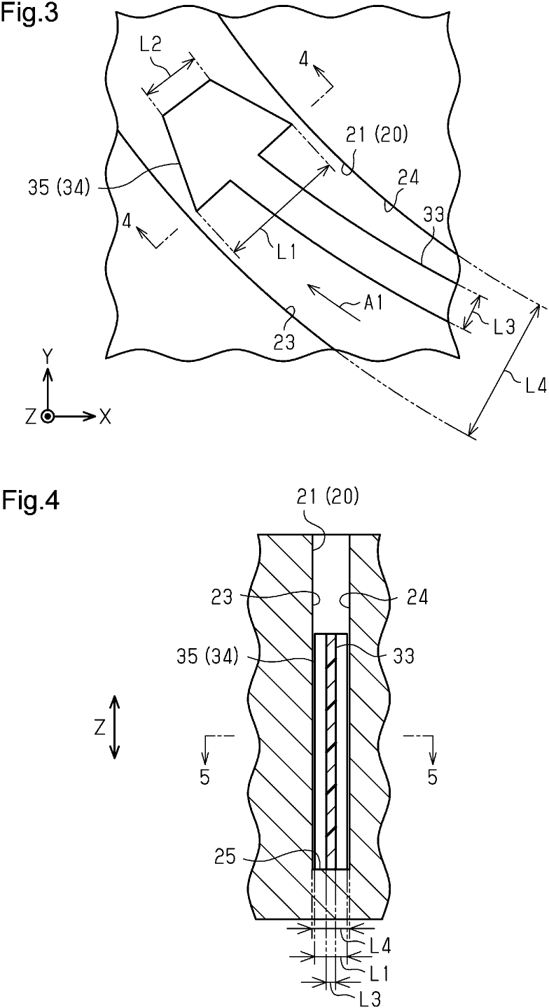

As shown in FIGS. 3 and 4, the thick portion 35 extends further downstream from the downstream end of the spacer plate 33 in the first passage 21.

An upstream thickness width dimension L1, which is the width dimension in the cylinder-radial direction of an upstream section of the thick portion 35, is greater than a downstream width dimension L2, which is the width dimension in the cylinder-radial direction of a downstream section of the thick portion 35. That is, the width dimension in the cylinder-radial direction of the thick portion 35 gradually decreases from the upstream side to the downstream side. The upstream thickness width dimension L1 is greater than a spacer width dimension L3, which is the width dimension in the cylinder-radial direction of the spacer plate 33. The upstream thickness width dimension L1 is shorter than a jacket width dimension L4, which is the width dimension in the cylinder-radial direction of the water jacket 20. The jacket width dimension L4 of the water jacket 20 represents a width dimension of a passage defined by the water jacket 20. That is, the jacket width dimension L4 of the water jacket 20 represents the distance between the radially outer partition wall 23 and the radially inner partition wall 24.

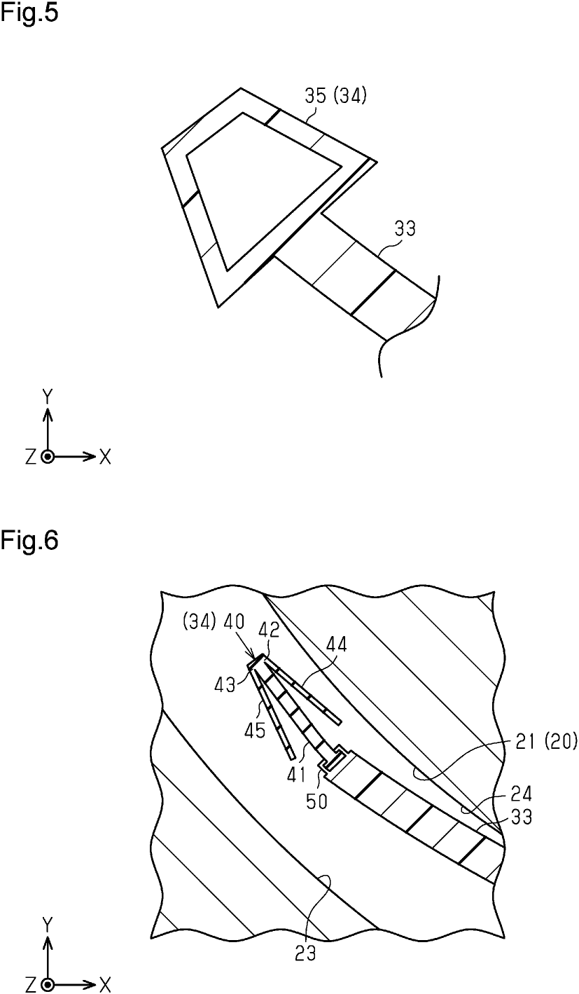

As shown in FIG. 5, the inside of the thick portion 35 is hollow.

Operation of the present embodiment will now be described.

When the internal combustion engine is operated, coolant is supplied to the water jacket 20 from the inlet 13 shown in FIG. 1. As indicated by a first arrow A1 and a second arrow A2 in FIG. 1, the coolant supplied from the inlet 13 to the water jacket 20 is branched and flows into the first passage 21 and the second passage 22. The first arrow A1 represents a flow direction of the coolant flowing through the first passage 21 in FIG. 1. The second arrow A2 represents a flow direction of the coolant flowing through the second passage 22 in FIG. 1. The coolant flowing through the first passage 21 and the coolant flowing through the second passage 22 join at the discharge section 14 and flow into the inflow port 15.

The restricting portion 34 of the first water jacket spacer 31 is located in the first passage 21. The restricting portion 34 has the upstream thickness width dimension L1, which is greater than the spacer width dimension L3 of the spacer plate 33. For this reason, the cross-sectional flow area in the section of the first passage 21 in which the restricting portion 34 is provided is smaller than the cross-sectional flow area of the second passage 22. Therefore, it becomes difficult for the coolant to flow through the first passage 21.

Advantages of the present embodiment will now be described.

1) The restricting portion 34 makes it difficult for the coolant to flow through the first passage 21. As a result, the amount of the coolant flowing through the first passage 21 is made smaller than the amount of the coolant flowing through the second passage 22. Therefore, a decrease in the cooling efficiency of the internal combustion engine is suppressed.

The upstream thickness width dimension L1 of the thick portion 35 is shorter than the jacket with dimension L4 in the cylinder-radial direction of the water jacket 20. Therefore, when the first water jacket spacer 31 is disposed by being inserted into the water jacket 20, a gap can be provided between the restricting portion 34 and each of the radially outer partition wall 23 and the radially inner partition wall 24 of the water jacket 20. As a result, the restricting portion 34 and the water jacket 20 are prevented from rubbing against each other, so that the restricting portion 34 and the water jacket 20 are prevented from wearing.

(1-2) The restricting portion 34 is the thick portion 35, which is formed integrally with the spacer plate 33. Therefore, the restricting portion 34 is implemented easily.

3) The width dimension in the cylinder-radial direction of the thick portion 35 decreases toward the downstream side.

With the above-described configuration, by increasing the upstream thickness width dimension L1 of the thick portion 35, the cross-sectional flow area of the section of the first passage 21 in which the restricting portion 34 is provided is reduced. Further, by narrowing the downstream width dimension L2 of the thick portion 35, the downstream section of the thick portion 35 is further less likely to come into contact with the radially outer partition wall 23 and the radially inner partition wall 24 of the water jacket 20 when the first water jacket spacer 31 is disposed by being inserted into the water jacket 20.

(1-4) The inside of the thick portion 35 is hollow.

With the configuration described above, when the first water jacket spacer 31 is disposed by being inserted into the water jacket 20, the load acting on the thick portion 35 is dispersed even if the thick portion 35 comes into contact with the radially outer partition wall 23 and the radially inner partition wall 24 of the water jacket 20. Therefore, wear of the thick portion 35 and the water jacket 20 is further suppressed.

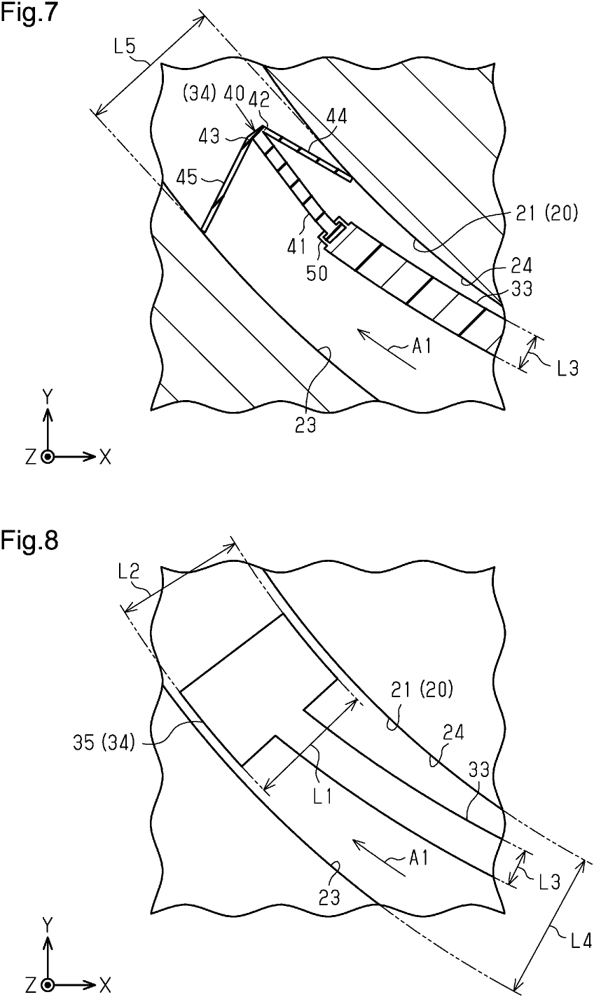

Hereinafter, a cylinder block 10 according to a second embodiment will be described with reference to FIGS. 6 and 7. In the second embodiment, since the configuration of the restricting portion 34 is different from that of the first embodiment, the differences from the first embodiment will be mainly described. In the second embodiment, components that are the same as or correspond to those of the first embodiment are denoted by the same reference numerals, and redundant description thereof will be omitted.

As shown in FIG. 6, in the second embodiment, the restricting portion 34 is an elastic member 40 separate from the spacer plate 33. The elastic member 40 includes an attachment portion 41, an inner movable piece 44, and an outer movable piece 45.

A gripping portion 50 is provided at the downstream end of the spacer plate 33. The attachment portion 41 is attached to the spacer plate 33 by gripping the upstream section of the attachment portion 41 with the gripping portion 50. Further, the attachment portion 41 has a plate shape extending downstream from the spacer plate 33. An inner connection portion 42 is provided at an inner portion of the downstream end of the attachment portion 41. An outer connection portion 43 is provided at an outer portion of the downstream end of the attachment portion 41.

The inner movable piece 44 extends upstream from the inner connection portion 42 so as to be wider in the cylinder-radial direction than the spacer plate 33 with respect to the inner connection portion 42. A gap is provided between the inner movable piece 44 and the attachment portion 41. The outer movable piece 45 extends upstream from the outer connection portion 43 so as to be wider in the cylinder-radial direction than the spacer plate 33 with respect to the outer connection portion 43. A gap is provided between the outer movable piece 45 and the attachment portion 41.

Operation of the present embodiment will now be described.

As shown in FIG. 7, the coolant flowing from the upstream side to the downstream side enters between the inner movable piece 44 and the attachment portion 41 and between the outer movable piece 45 and the attachment portion 41. Then, the inner movable piece 44 is spread away from the attachment portion 41 in the cylinder-radial direction with respect to the inner connection portion 42. Further, the outer movable piece 45 is spread away from the attachment portion 41 in the cylinder-radial direction with respect to the outer connection portion 43. As a result, a restricting width dimension L5, which is the width dimension in the cylinder-radial direction of the restricting portion 34, becomes greater than the spacer width dimension L3 in the cylinder-radial direction of the spacer plate 33.

Advantages of the present embodiment will now be described.

1) The inner movable piece 44 and the outer movable piece 45 spread in the cylinder-radial direction. Therefore, the cross-sectional flow area of the second of the first passage 21 in which the restricting portion 34 is provided is smaller than the cross-sectional flow area of the second passage 22. Therefore, the amount of the coolant flowing through the first passage 21 is made smaller than the amount of the coolant flowing through the second passage 22.

### Modification

The above-described embodiments can be modified as follows. The above-described embodiments and the following modifications can be implemented in combination with each other as long as there is no technical contradiction.

In the second embodiment, one of the inner movable piece 44 and the outer movable piece 45 may be omitted.

In the first embodiment, the inside of the thick portion 35 may be filled with the same plastic as the plastic of the spacer plate 33.

As shown in FIG. 8, in the first embodiment, if the upstream thickness width dimension L1 in the cylinder-radial direction of the thick portion 35 is greater than the spacer width dimension L3 in the cylinder-radial direction of the spacer plate 33, the following modifications may be made. That is, the upstream thickness width dimension L1 in the cylinder-radial direction of the thick portion 35 may be equal to the downstream width dimension L2 in the cylinder-radial direction of the thick portion 35.

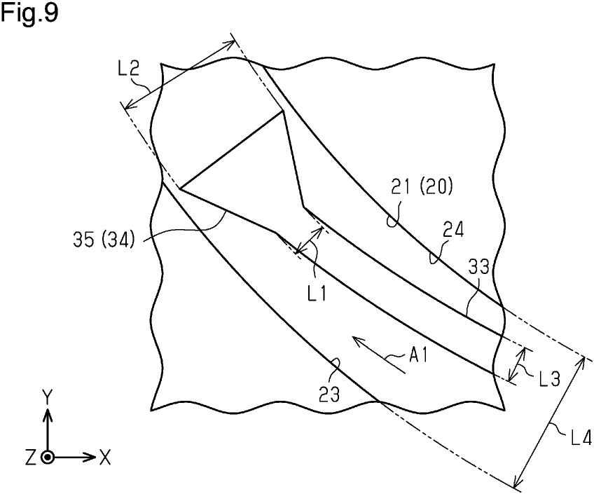

As shown in FIG. 9, in the first embodiment, the upstream width dimension (L1) in the cylinder-radial direction of the thick portion 35 may be smaller than the downstream width dimension L2 in the cylinder-radial direction of the thick portion 35. In this case, the downstream width dimension L2 in the cylinder-radial direction of the thick portion 35 is greater than the spacer width dimension L3 in the cylinder-radial direction of the spacer plate 33. The downstream width dimension L2 of the thick portion 35 is shorter than the jacket width dimension L4 in the cylinder-radial direction of the water jacket 20.

In the first embodiment, the thick portion 35 may be provided at any position on the spacer plate 33 as long as the thick portion 35 is provided in the first passage 21. That is, the thick portion 35 is not limited to being positioned at the downstream end of the spacer plate 33, but may be provided at a middle section of the spacer plate 33.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cylinder block, comprising:
a water jacket surrounding a cylinder of an internal combustion engine;
a water jacket spacer disposed inside the water jacket;
an inlet that conduct coolant into the water jacket; and
a discharge section that discharges the coolant from the water jacket, wherein
the water jacket includes:
a first passage connecting the inlet to the discharge section; and
a second passage connecting the inlet to the discharge section,
the first passage is shorter than the second passage,
the water jacket spacer includes:
a spacer plate; and
a restricting portion provided on the spacer plate,
the restricting portion is located in the first passage,
a width dimension of the restricting portion is larger than a width dimension in a cylinder-radial direction of the spacer plate, the cylinder-radial direction being a radial direction of the cylinder, and
the width dimension of the restricting portion is smaller than a width dimension in the cylinder-radial direction of the water jacket.

2. The cylinder block according to claim 1, wherein
the restricting portion includes a thick portion formed integrally with the spacer plate, and
a width dimension in the cylinder-radial direction of the thick portion is partially increased in the spacer plate.

3. The cylinder block according to claim 2, wherein
in the first passage, a direction toward the inlet is an upstream direction, and a direction toward the discharge section is a downstream direction, and
the width dimension in the cylinder-radial direction of the thick portion decreases toward a downstream side.

4. The cylinder block according to claim 2, wherein an interior of the thick portion is hollow.

5. The cylinder block according to claim 1, wherein
a direction toward a center of the cylinder in the cylinder-radial direction is an inward direction, and a direction away from the center in the cylinder-radial direction is an outward direction,
in each of the first passage and the second passage, a direction toward the inlet is an upstream direction, and a direction toward the discharge section is a downstream direction,
the restricting portion is an elastic member separate from the spacer plate,
the elastic member includes:
an attachment portion attached to the spacer plate; and
a movable piece;
the movable piece includes a connection portion connected to an inner side or an outer side of the attachment portion, and
the movable piece extends upstream from the connection portion so that the movable piece is wider in the cylinder-radial direction than the width dimension in the cylinder-radial direction of the spacer plate with reference to the connection portion.
